(19) United States
(12) Patent Application Publication
(10) Pub. No.: US 2002/0147606 A1
(43) Pub. Date: Oct. 10, 2002

(54) Application development method

(76) Inventors: Norbert Hoffmann, Rottenschwil (CH); Steve Briscoe, Harston (GB); Phil Main, Wheathampstead (GB)

Correspondence Address: Clifford Chance Rogers & Wells LLP, 200 Park Avenue, New York, NY, 10166-0153, US

(21) Appl. No.: 10/037,938

(22) Filed: Jan. 3, 2002

Related U.S. Application Data
(60) Provisional application No. 60/275,884, filed on Mar. 14, 2001.

(51) Int. Cl. G06F 17/60

(52) U.S. Cl. 705/1; 705/7

(57) ABSTRACT

A method is provided for developing an application and includes a step of selecting one of a plurality of patterns wherein each of the plurality of patterns have at least one of a plurality of business artifacts. Next, the application is designed using the at least one of the plurality of business artifacts associated with the selected one of the plurality of patterns. Next, code based on the at least one of the plurality of business artifacts is generated. Finally, the code is interfaced with at least one platform independent service.

### CROSS-REFERENCE TO RELATED APPLICATION

This application claims the benefit of the filing date of U.S. Provisional Application serial No. 60/275,884 entitled “METHOD AND SYSTEM FOR AUTOMATING APPLICATION DEVELOPMENT” which was filed on Mar. 14, 2001.

### BACKGROUND

The following invention relates software development and, in particular, to a method for efficiently developing and maintaining business software.

Organizations spend considerable resources in developing and maintaining computer system software to meet the business needs of the organization. Typically, the process of developing business software begins with the ultimate users of the software specifying the functions the software is to perform and communicating those specifications to software developers. The software developers then take these functional requirements and write program code that, when compiled into an executable program, will perform the specified functions.

Often, the software developers will have to rewrite portions of the program code in order to meet the needs of the user. In some cases, the program code originally produced by the software developers may not have met the requirements as specified by the user and thus may require modification. In other situations, the user may have changed the original specification thereby causing the software developers to have to make modifications accordingly. In either case, the software developers typically modify portions of the previously written program code so that the resulting software program meets the requirements of the user.

The prior art process of developing business applications is fraught with inefficiencies. The requirements for business applications are typically identified and specified by the business users who then communicate these requirements to the software developers. During this process, there are often miscommunications and misunderstandings between the business users and the software developers as to the precise functional requirements the software program is to meet. As a result, the software developers may have to make numerous revisions to the program code in order to fully satisfy the requirements of the business user. Aside from the time and costs associated with undergoing numerous revision cycles, the resulting program code is often difficult to maintain as a result of the many changes made by the software developers. Furthermore, as these changes are continuously made, the original design specification produced by the business users no longer accurately documents the actual operation of the final version of the business application.

Additional inefficiencies arise in the development of business applications in a large organizations that employ numerous business applications. Large organizations typically form several software development teams that each perform the software development for different groups of business users. In many cases, the development projects of some of the software development teams have common requirements such as, for example, communicating with various computer systems. It is difficult, however, to coordinate the different development teams so that program code needed to satisfy the common requirements is shared between the teams. What often occurs is that each team separately writes program code to perform these common requirements which necessarily increases the development and maintenance costs of the business applications.

Another significant drawback of having several teams develop business software applications in a large organization is that often different business applications need to communicate with each other in order to achieve an organization-wide purpose. For example, in a financial institution, a software application designed to execute a trade request of a client typically communicates with a software application that settles the trade and confirms the trade to client. If each of the business applications developed by different development teams are designed using different software development methodologies, considerable modifications are often required to have the different business applications properly communicate with each other.

Accordingly, it is desirable to provide a method and system for the efficient development and maintenance of business software.

### SUMMARY OF THE INVENTION

The present invention is directed to overcoming the drawbacks of the prior art. Under the present invention a method is provided for developing an application and includes a step of selecting one of a plurality of patterns wherein each of the plurality of patterns have at least one of a plurality of business artifacts. Next, the application is designed using the at least one of the plurality of business artifacts associated with the selected one of the plurality of patterns. Next, code based on the at least one of the plurality of business artifacts is generated. Finally, the code is interfaced with at least one platform independent service.

In an exemplary embodiment, the plurality of patterns includes a process workflow application pattern, a service request application pattern, a web-based application pattern and a reporting pattern.

In another exemplary embodiment, the plurality of business artifacts includes a process business artifact, an activity business artifact, a user interface business artifact, a business object business artifact and a data business artifact.

In yet another exemplary embodiment, the plurality of patterns include a process workflow application pattern and the at least one of the plurality of business artifacts associated with the process workflow application pattern includes a process business artifact, an activity business artifact, a user interface business artifact, a business object business artifact and a data business artifact.

In still yet another exemplary embodiment, the plurality of patterns include a service request application pattern and the at least one of the plurality of business artifacts associated with the service request application pattern includes an activity business artifact, a business object business artifact and a data business artifact.

In an exemplary embodiment, the plurality of patterns include a web-based application pattern and the at least one of said plurality of business artifacts associated with the web-based application pattern includes a user-interface business artifact, a business object business artifact and data business artifact.

In another exemplary embodiment, the plurality of patterns include a reporting pattern and the at least one of said plurality of business artifacts associated with the reporting pattern includes a user interface business artifact and a data business artifact.

In yet another exemplary embodiment, a plurality of business artifact services are included and includes the step of interfacing the code with the at least one platform independent service via the business artifact services.

In still yet another exemplary embodiment, the business artifact services includes a workflow framework, an activity framework, a user interface services, a business object framework and a database.

In an exemplary embodiment, the platform independent services include logging services, security services, messaging services and transaction services.

In another exemplary embodiment the at least one platform independent service is interfaced with a platform specific adapter.

In yet another exemplary embodiment, the platform specific adapter is selected from a group including an NT adapter, a Solaris adapter and a S390 adapter.

In still yet another exemplary embodiment, a workflow using said at least one of the plurality of business artifacts is formed.

In an exemplary embodiment, the application is modified by changing at least one of the plurality of business artifacts associated with the selected one of the plurality of patterns and regenerating code based on the at least one of the plurality of business artifacts.

In another exemplary embodiment, the code is converted into an executable format.

Under the present invention, a system for developing an application is provided and includes a modeling engine for selecting one of a plurality of patterns, each of the plurality of patterns having at least one of a plurality of business artifacts, and for designing the application using the at least one of the plurality of business artifacts associated with the selected one of the plurality of patterns. Also included is a forward engineering module for generating code based on the at least one of the plurality of business artifacts wherein the code interfaces with at least one platform independent service.

In an exemplary embodiment, a plurality of business artifact services are included and the code interfaces with the at least one platform independent service via the business artifact services.

In another exemplary embodiment, the at least one platform independent service interfaces with a platform specific adapter.

In yet another exemplary embodiment, a workflow is formed using the at least one of the plurality of business artifacts.

In still yet another exemplary embodiment, the application is modified by changing at least one of the plurality of business artifacts associated with the selected one of the plurality of patterns and the code based on the at least one of the plurality of business artifacts is regenerated.

In an exemplary embodiment, the forward engineering module converts the code into an executable format.

Under the present invention, a method for developing an application is provided and includes a means for selecting one of a plurality of patterns, each of the plurality of patterns having at least one of a plurality of business artifacts; a means for designing the application using the at least one of the plurality of business artifacts associated with the selected one of the plurality of patterns; a means for generating code based on the at least one of the plurality of business artifacts; and a means interfacing the code with at least one platform independent service.

Accordingly, a method and system is provided for the efficient development and maintenance of business software.

The invention accordingly comprises the features of construction, combination of elements and arrangement of parts that will be exemplified in the following detailed disclosure, and the scope of the invention will be indicated in the claims. Other features and advantages of the invention will be apparent from the description, the drawings and the claims.

### DESCRIPTION OF THE DRAWINGS

For a fuller understanding of the invention, reference is made to the following description taken in conjunction with the accompanying drawings, in which:

FIG. 1 is a block diagram illustrating a workflow application pattern according to the present invention;

FIG. 2 is a block diagram illustrating a web-based application pattern according to the present invention;

FIG. 3 is a block diagram illustrating a reporting application pattern according to the present invention;

FIG. 4 is a block diagram illustrating a service request application pattern according to the present invention;

FIG. 5 is a flowchart of the process by which a business application is developed according to the present invention;

FIG. 6 is a block diagram of a system for developing business applications according to the present invention; and

FIG. 7 is an activity diagram for checking the validity of an address according to an exemplary embodiment of the present invention.

### DETAILED DESCRIPTION OF THE PREFERRED EMBODIMENTS

The present invention provides a method for efficiently developing and maintaining business software applications. Central to the method of the present invention is the use of application patterns. An application pattern is a template used for building a software application that implements a solution to a particular business problem. In an exemplary embodiment various application patterns exist with each being suitable for building a different class of business applications. Because the application patterns of the present invention formalizes the development of business applications, as will be described below, the use of applications patterns enables an organization to generate business applications quickly and consistently across the entire organization.

Application patterns consist of business artifacts that are the building blocks with which business applications are constructed. The number and type of business artifacts that are included in a particular application pattern depends on the type of business application the particular application pattern is designed to solve.

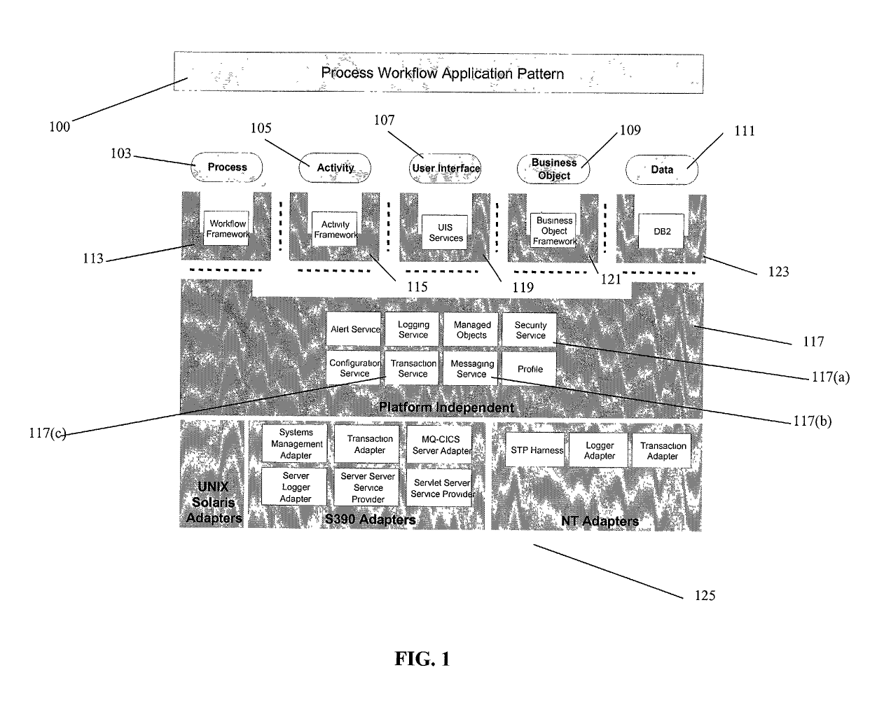

Referring now to FIG. 1, there is shown a block diagram illustrating a workflow application pattern 100. Workflow application pattern 100 is suitable for building mission-critical business applications that are characterized by a high-degree of repetition and automation and that require a high-volume, high-reliability and high-throughput transaction processing capability. In order to build such business applications, workflow application pattern 100 uses the following five business artifacts: a process business artifact 103, an activity business artifact 105, a user-interface business artifact 107, a business object business artifact 109 and a data business artifact 111.

Process business artifact 103 is a workflow process definition that describes the mechanism by which a business operation is to be carried out. More specifically, process business artifact 103 describes a number of activities that are to be used to solve a particular business problem and a number of rules that govern the operation flow between those activities. In an exemplary embodiment, a workflow process definition may be constructed using a software tool called Rational Rose (http://www.rational.com/products/rose/index.jsp) for visually modeling the activities and rules that form a workflow process definition.

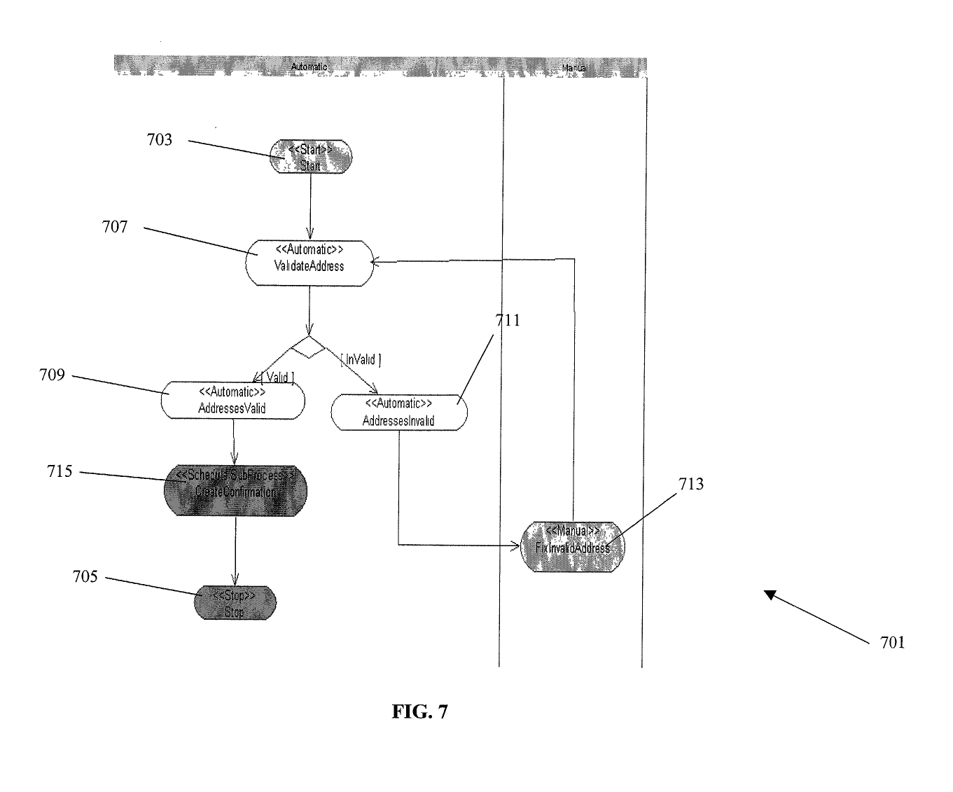

Once a workflow process definition associated with process business artifact 103 is formed, the workflow process definition is received by a workflow framework business artifact service 113 that transforms the workflow process definition into software code that forms the code skeleton of the desired business application. Referring now to FIG. 7, there is shown an activity diagram 701 for checking the validity of an address that may be part of a workflow process definition, according to an exemplary embodiment. In addition to a start node 703 and a stop node 705, activity diagram 701 includes a ValidateAddress automatic activity 707, an AddressValid automatic activity 709 and an AddressInvalid automatic activity 711. Also included in activity diagram 701 is a FixInvalidAddress manual activity 713 and a CreateConfirmation subprocess 715. In an exemplary embodiment, workflow framework business artifact service 113 receives activity diagram 701 and generates the code example contained in Exhibit A of the Appendix. Workflow framework 113 may forward engineer a workflow process definition into any type of software code suitable for developing a business application including, by way of non-limiting example, Java code. The process of transforming a workflow process definition into software code may be performed using Together ControlCenter from TogetherSoft (http ://www.togethersoft.com/products/controlcenter/index.jsp;jsessionid=mtfwcen1t1.www6).

Activity business artifacts 105 are the individual business functions that are included in the workflow process definition that are required solve the particular business problem and represent the lowest level of decomposition within a workflow process definition. In an exemplary embodiment, activity business artifacts 105 include both automatic activities as well as manual activities that require user intervention. In an automated activity, the functions associated with the activity is performed by software whereas in a manual activity the work is performed by a user of the business application. In an exemplary embodiment, activities may change between being automatic and manual, for example, when the volume of a manual activity increases sufficiently to make it cost effective to be automated.

An activity may be specified to any level of granularity as desired. In an exemplary embodiment, the level of granularity should be selected to maximize the ease by which the workflow in the process definition can be changed and increase the opportunity to re-use the activity in different business applications. For example, in the context of a trading system, a finely grained activity to validate an instrument that is a subject of a trade may be applicable across all trade and product types. However, a coarser grained activity to validate a trade may require logic for specific product types (for e.g., equity and fixed income) and therefore may not be useable across different the product types.

In an exemplary embodiment, manual activities are presented to the user through a user-interface (to be described below) that presents the user with what is needed to complete the work to be done by the business application. For example, in the context of a trading system, a manual activity may require the user to handle an exception (for e.g., something wrong with the trade details) or provide an authorization (for e.g., release of a free of payment instruction).

Once the functions associated with activity business artifact 105 are specified, the fuctions are received by an activity framework business artifact service 115 that transforms the functions' specifications into software code sections that perform these functions. These code sections may include the middleware required to access any of a plurality of platform independent services 117 such as, by way of non-limiting example, security services 117(a), messaging services 117(b) and transaction services 117(c). These code sections interface with the code skeleton generated by workflow framework 113, as required. Exhibit B of the Appendix shows the generated code sections that interface with the code skeleton of Exhibit A associated with activity diagram 601, according to an exemplary embodiment. Activity framework 115 may forward engineer a functional description of an activity into any type of software code suitable for developing a business application including, by way of non-limiting example, Java code.

User-interface business artifact 107 is a mechanism by which users interact with a business application. For example, user-interface business artifact 107 may enable a business user to view and manually resolve exceptions that may prevent the filly automated execution of a workflow process.

Once the mechanism associated with user-interface business artifact 107 is specified, the specification is received by a UIS services business artifact service 119 that generates the necessary codes sections to implement the specified user interaction. These code sections also interface with the code skeleton generated by workflow framework 113, as required. In an exemplary embodiment, UIS services 119 may generate code sections for implementing a graphical user-interface via which a user performs manual activities in connection with the operation of the business application, as required. Exhibit C of the Appendix includes an exemplary code section for a user interface for the FixInvalidAddress manual activity 613 included in activity diagram 601.

Business object business artifact 109 is a software entity that encapsulates functional logic and data that is used by the business application and that includes a programmatic interface by which operations may be performed on a business object. Activity business artifacts 105 are carried out by performing operations on business object business artifacts 109.

Once the business logic and data associated with business object business artifacts 109 is specified, the specification is received by a business object factory business artifact service 121 that generates the necessary codes sections to retrieve the required data and perform the specified business logic on the retrieved data. These code sections also interface with the code skeleton generated by workflow framework 113, as required. Exhibit D of the Appendix includes a code section to retrieve data and perform specified business logic on the retrieved data, according to an exemplary embodiment.

Finally, data business artifacts 111 are the individual pieces of information that are encapsulated within business object business artifacts 109 and upon which the business logic contained in business object business artifacts 109 is performed. The data is stored in a database business artifact services 123 such as, by way of non-limiting example, a DB2 database server.

Once the relevant code sections for the particular application are generated, the application is initiated via workflow routing software that invokes the codes sections as required. Exhibit E of the Appendix is an exemplary workflow routing software that invokes the relevant classes and methods for a particular workflow application.

An example of a workflow application pattern that uses the five business artifacts is a securities settlement system that includes a process (workflow) of settling trades (business objects) that were executed by a trading system. The process includes tasks that are automatically performed by the system (automatic activities) that may include, for example, determining the account balance of the party executing a particular trade. The process may also include a manual activity in which a user overseeing the operation of settlement system must contact the trading party to resolve any discrepancy in the trading party's account information.

Platform independent services 117 interfaces with any of a plurality of platform adapters 125 so that the resulting business application may execute on and interface with a corresponding operating environment. Platform adapters 125 may include, by way of non-limiting example, adapters for interfacing the business application to a Windows NT platform, an IBM S390 platform and a Solaris platform.

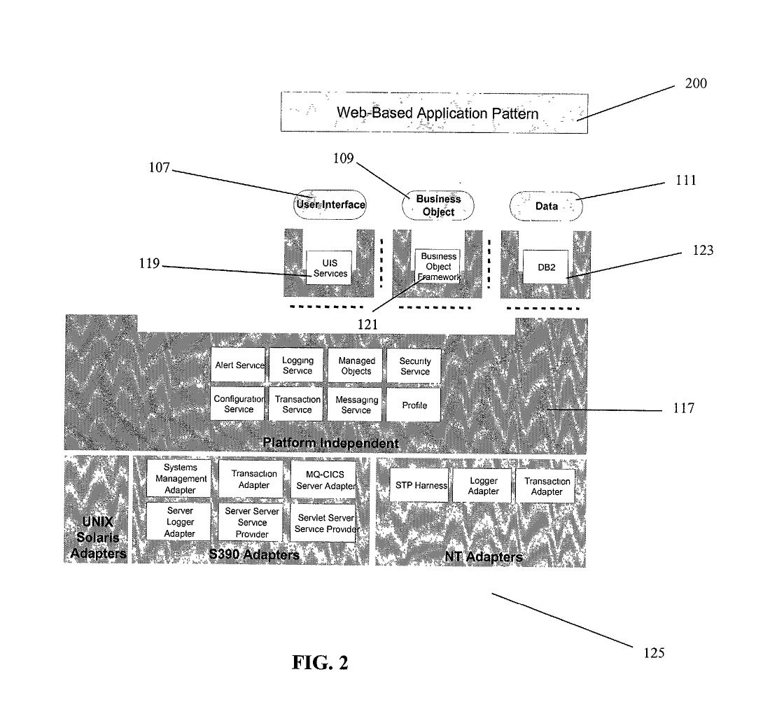

Referring now to FIG. 2, there is shown a block diagram illustrating a web-based application pattern 200. Elements that are similar to elements included in the embodiment of FIG. 1 are identically labeled and a detailed description thereof is eliminated.

Web-based application pattern 200 is used for building business applications that retrieve and display business data to a web-based front-end as well as store to a database updated or newly entered data received via the front-end. In order to build business applications that conform to web-based application pattern 200, only user-interface business artifact 107, business object business artifact 109 and data business artifacts 111 are required. Because these business applications do not include a workflow and activities being performed within a workflow, web-based application pattern 200 does not require process and activity business artifacts. Exhibit F of the Appendix includes an example of a user-interface business artifact, business object business artifact and data artifact associated with a web-based application for fixing an invalid address.

Once the desired business artifacts are selected, the specified business artifacts are received by UIS services business artifacts services 119, business object business artifacts services 121 and data business artifacts services 123, respectively, for generating the code sections that result in the desired business application. These code sections interface with platform independent services 117, as required. Furthermore, because process and activity business artifacts are not used in business applications that conform to web-based application pattern 200, code sections that are associated with those business artifacts are eliminated from the resulting code that forms the business application.

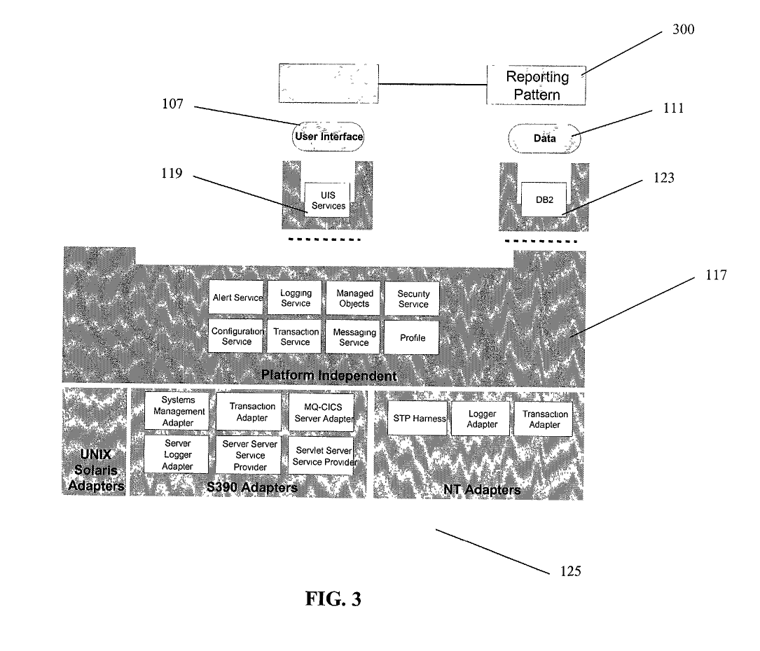

Referring now to FIG. 3, there is shown a block diagram illustrating a reporting application pattern 300. Elements that are similar to elements included in the embodiment of FIG. 1 are identically labeled and a detailed description thereof is eliminated.

Reporting application pattern 300 is used for building applications in which information is delivered to any output device such as, by way of non-limiting example, a web-browser, a printer or an application program (for example, an Excel spreadsheet). In an exemplary embodiment, the reporting application pattern includes tools such as, by way of non-limiting example, style sheets that may be used for conforming reports to any desired look and feel. In order to build business applications that conform to reporting application pattern 300, only user-interface business artifact 107 and data business artifact 111 are used. Exhibit G of the Appendix includes an example of a user-interface business artifact and data artifact associated with a reporting application for responding to transaction inquiries.

Once the desired business artifacts are selected, the specified business artifacts are received by UIS services business artifacts services 119 and data business artifacts services 123, respectively, for generating the code sections that result in the desired business application. These code sections interface with platform independent services 117, as required. Furthermore, because process, activity and business object business artifacts are not used in business applications that conform to reporting application pattern 300, code sections that are associated with those business artifacts are eliminated from the resulting code that forms the business application.

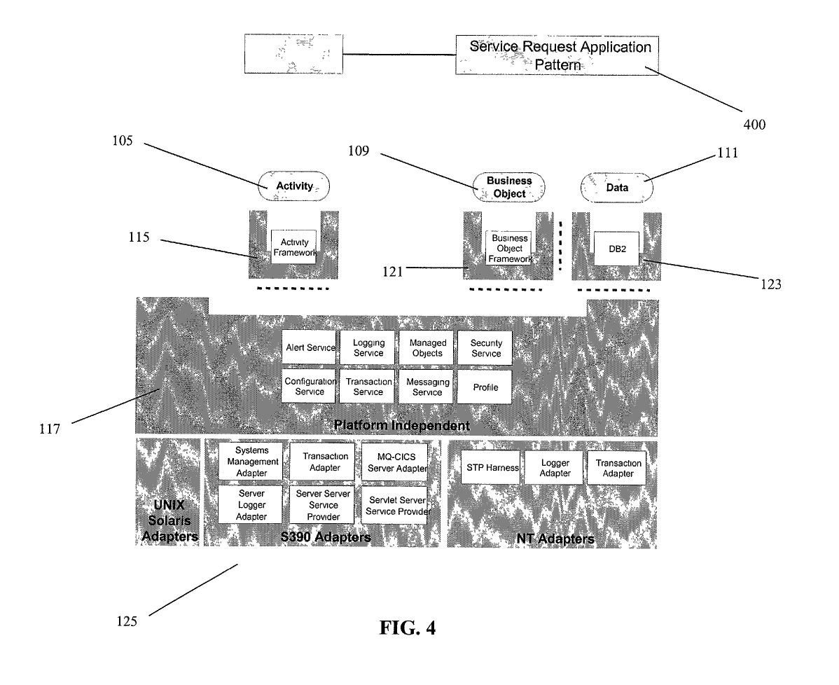

Referring now to FIG. 4, there is shown a block diagram illustrating a service request application pattern 400. Elements that are similar to elements included in the embodiment of FIG. 1 are identically labeled and a detailed description thereof is eliminated.

Service request application pattern 400 is used for building business applications in which a two systems directly communicate with each other. An example of such a business application is a settlement system requesting from a trading system information regarding executed trades and the trading system replying to the settlement system with the requested information. In order to build business applications that conform to service request application pattern 400, activity business artifact 105, business object business artifact 109 and data business artifact 111 are used. Exhibit H of the Appendix includes an example of activity business artifacts, business object business artifacts and data artifacts associated with a configuration service request application.

Once the desired business artifacts are selected, the specified business artifacts are received by activity framework business artifacts services 115, business object factory business artifact services 212 and data business artifacts services 123, respectively, for generating the code sections that result in the desired business application. These code sections interface with platform independent services 117, as required. Furthermore, because process and user-interface business artifacts are not used in business applications that conform to service request application pattern 400, code sections that are associated with those business artifacts are eliminated from the resulting code that forms the business application.

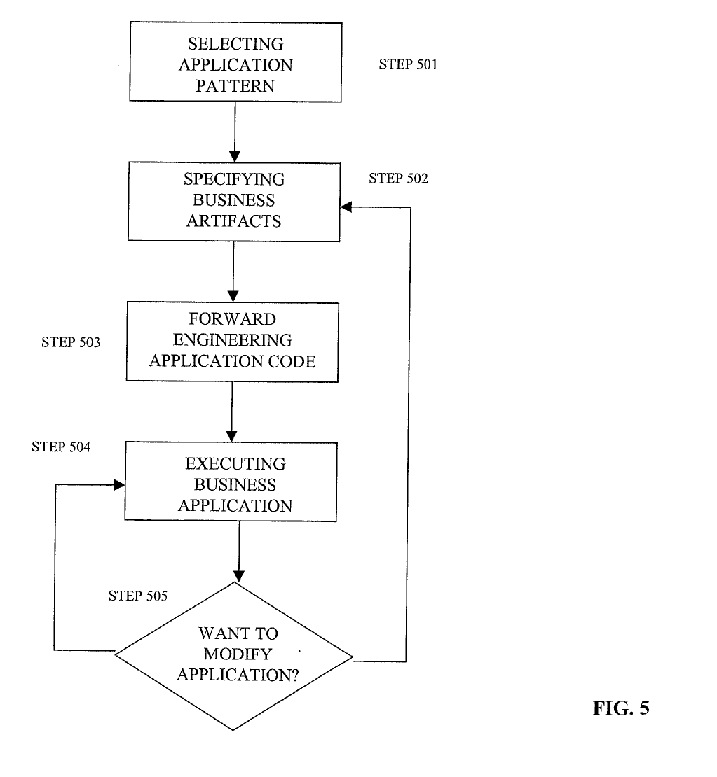

Referring now to FIG. 5, there is shown a flowchart of the process by which a business application is developed according to the present invention. Initially, in Step 501 the developer selects the type of application pattern that is suited for solving a particular business problem. Next, in Step 502, for each of the business artifacts types used by the selected application pattern, the developer specifies the business artifacts that perform the functional requirements of the business application. Once the business artifacts are specified, then in Step 503, the code for the business application is forward engineered based on the specified business artifacts. Next, in Step 504, the code is compiled thereby producing an executable business application that solves the particular business problem.

Next, in Step 505, it is determined whether the developer desires to make modifications to the resulting business application. Modifications may be made for any reason including either because the business artifacts as originally specified do not precisely solve the business problem or because the business problem to be solved has changed. In any case, if it is desired to modify the business application, the method returns to Step 502 in which case the business artifacts are specified again. The method then continues to Steps 503 and 504 in which the code underlying the business application is forward engineered and converted into an executable business application. It is important to note that according to the method of the present invention, any modifications made to a business application are performed by re-specifying the business artifacts and re-forward engineering the code for the business application. Modifications to the business application are not made, however, by making changes to the code directly. If changes are made to the code directly, then the functionality of the resulting business application will differ from the business application specification as embodied by the business artifacts. By requiring that modifications be made by re-specifying business artifacts, however, the functionality of the resulting business application is accurately described and documented by the specified business artifacts.

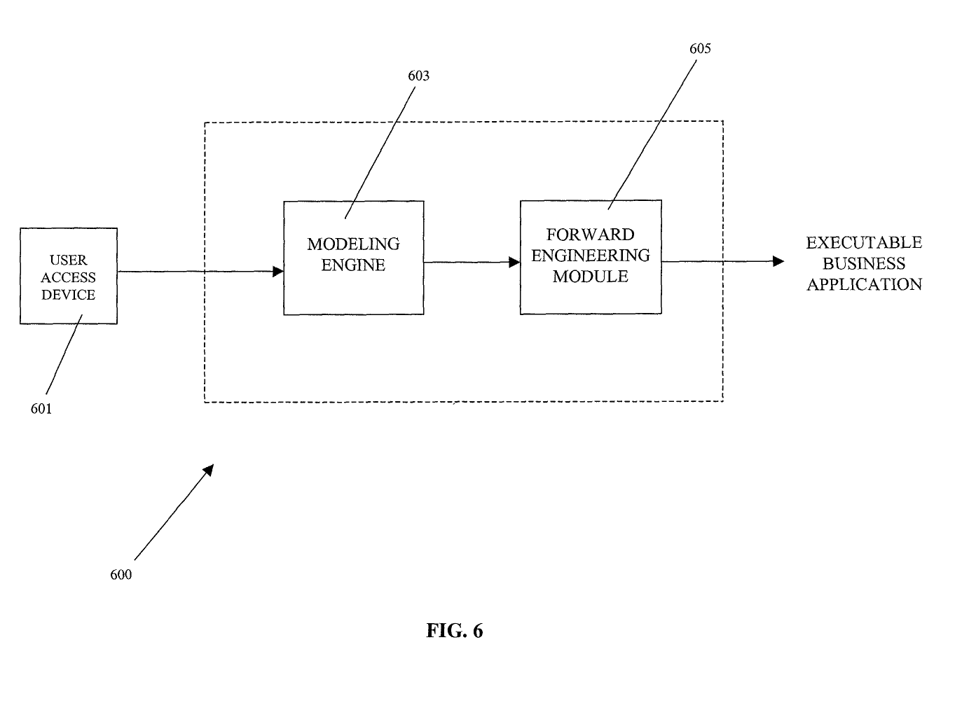

Referring now to FIG. 6, there is shown a block diagram of a system 600 for developing business applications according to the present invention. Included in system 600 is a modeling engine 603 that is accessed by a user operating a user access device (for e.g., a personal computer). Modeling engine 603 provides the user with the tools for specifying business artifacts and designing business applications using business artifacts in accordance with the methods described above. Once the user has specified and designed the business application using modeling engine 603, the design is forwarded by modeling engine 603 to a forward engineering module 605 that converts the modeled design into software code and outputs an executable business application that accurately reflects the design provided by the user.

In an exemplary embodiment, modeling engine 603 and forward engineering module 606 of system 600 are a software program executing on a computer that performs the functions described above.

Accordingly, under the present invention a method and system is provided for efficiently developing and maintaining business software applications. Because the business applications created using the present invention are developed using visual modeling tools, the applications may be completely specified by the business people that actually use the application. Also, the business users can easily redesign the business application by making changes to the specified business artifacts using the modeling tools. As a result, inefficiencies that typically arise from miscommunications between business users and software developers are eliminated.

Furthermore, because the business logic that represents the unique functionality of the business application is generated by the business people using modeling tools, the business logic is separately identifiable and not buried within the application code. As a result, the application model, that contains the specified business artifacts and upon which the generated application code is based, serves to accurately document the functionality of the resulting business application.

In addition, by structuring applications using the types of business artifacts that are required to support a particular application type, legacy business applications can be effectively re-engineered by breaking up their implementation into reusable workflows, activities, and business objects according to the methods of the present invention.

Yet another benefit of developing business applications using the method of the present invention is that the platform and infrastructure upon which the business applications run is generic and does not contain code that is specific to any particular business application. Accordingly, a large percentage of a business application developed according the present invention consists of application code that is common to other business applications developed using these methods. Business applications are therefore distinguished solely on the business logic and business artifacts specific to the particular business application. Furthermore, because business applications shared a common code structure, the connectivity between such business applications and between the business applications and operating platforms and systems are greatly simplified.

A number of embodiments of the present invention have been described. Nevertheless, it will be understood that various modifications may be made without departing from the spirit and scope of the invention. Based on the above description, it will be obvious to one of ordinary skill to implement the system and methods of the present invention in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Furthermore, alternate embodiments of the invention that implement the system in hardware, firmware or a combination of both hardware and software, as well as distributing modules and/or data in a different fashion will be apparent to those skilled in the art and are also within the scope of the invention. In addition, it will be obvious to one of ordinary skill to use a conventional database management system such as, by way of non-limiting example, Sybase, Oracle and DB2, as a platform for implementing the present invention. Also, network access devices can comprise a personal computer executing an operating system such as Microsoft Windows™, Unix™, or Apple Mac OS™, as well as software applications, such as a JAVA program or a web browser. Network access devices 203-205 can also be a terminal device, a palm-type computer, mobile WEB access device or other device that can adhere to a point-to-point or network communication protocol such as the Internet protocol. Computers and network access devices can include a processor, RAM and/or ROM memory, a display capability, an input device and hard disk or other relatively permanent storage. Accordingly, other embodiments are within the scope of the following claims.

It will thus be seen that the objects set forth above, among those made apparent from the preceding description, are efficiently attained and, since certain changes may be made in carrying out the above process, in a described product, and in the construction set forth without departing from the spirit and scope of the invention, it is intended that all matter contained in the above description shown in the accompanying drawing shall be interpreted as illustrative and not in a limiting sense.

It is also to be understood that the following claims are intended to cover all of the generic and specific features of the invention herein described, and all statements of the scope of the invention, which, as a matter of language, might be said to fall therebetween.

[image]

[image]

[image]

[image]

[image]

[image]

[image]

[image]

[image]

[image]

[image]

[image]

[image]

[image]

[image]

[image]

[image]

[image]

1. A method for developing an application, comprising:
selecting one of a plurality of patterns, each of said plurality of patterns having at least one of a plurality of business artifacts;
designing said application using said at least one of said plurality of business artifacts associated with said selected one of said plurality of patterns;
generating code based on said at least one of said plurality of business artifacts; and
interfacing said code with at least one platform independent service.

2. The method of claim 1, wherein said plurality of patterns includes a process workflow application pattern, service request application pattern, web-based application pattern and a reporting pattern.

3. The method of claim 1, wherein said plurality of business artifacts includes a process business artifact, an activity business artifact, a user interface business artifact, a business object business artifact and a data business artifact.

4. The method of claim 1, wherein said plurality of patterns include a process workflow application pattern and said at least one of said plurality of business artifacts associated with said process workflow application pattern includes a process business artifact, an activity business artifact, a user interface business artifact, a business object business artifact and a data business artifact.

5. The method of claim 1, wherein said plurality of patterns include a service request application pattern and said at least one of said plurality of business artifacts associated with said service request application pattern includes an activity business artifact, a business object business artifact and a data business artifact.

6. The method of claim 1, wherein said plurality of patterns include a web-based application pattern and said at least one of said plurality of business artifacts associated with said web-based application pattern includes a user-interface business artifact, a business object business artifact and data business artifact.

7. The method of claim 1, wherein said plurality of patterns include a reporting pattern and said at least one of said plurality of business artifacts associated with said reporting pattern includes a user interface business artifact and a data business artifact.

8. The method of claim 1, further comprising a plurality of business artifact services and the step of interfacing said code with at least one platform independent service includes the step of:
interfacing said code with said at least one platform independent service via said business artifact services.

9. The method of claim 8, wherein said business artifact services includes a workflow framework, an activity framework, user interface services, a business object framework and database application.

10. The method of claim 1, wherein said platform independent services include logging services, security services, messaging services and transaction services.

11. The method of claim 1, further comprising the step of:
interfacing said at least one platform independent service with a platform specific adapter.

12. The method of claim 11, wherein said platform specific adapter is selected from a group including an NT adapter, a Solaris adapter and a S390 adapter.

13. The method of claim 1, wherein the step of designing said application includes the step of:
forming a workflow using said at least one of said plurality of business artifacts.

14. The method of claim 1, wherein said application is to be modified and wherein the method further comprises the steps of:
changing at least one of said plurality of business artifacts associated with said selected one of said plurality of patterns; and
regenerating code based on said at least one of said plurality of business artifacts.

15. The method of claim 1, wherein the step of generating code includes the step of:
converting said code into an executable format.

16. A system for developing an application, comprising:
a modeling engine for selecting one of a plurality of patterns, each of said plurality of patterns having at least one of a plurality of business artifacts, and for designing said application using said at least one of said plurality of business artifacts associated with said selected one of said plurality of patterns; and
a forward engineering module for generating code based on said at least one of said plurality of business artifacts;
wherein said code interfaces with at least one platform independent service.

17. The system of claim 16, wherein said plurality of patterns includes a process workflow application pattern, service request application pattern, web-based application pattern and a reporting pattern.

18. The system of claim 16, wherein said plurality of business artifacts includes a process business artifact, an activity business artifact, a user interface business artifact, a business object business artifact and a data business artifact.

19. The system of claim 16, wherein said plurality of patterns include a process workflow application pattern and said at least one of said plurality of business artifacts associated with said process workflow application pattern includes a process business artifact, an activity business artifact, a user interface business artifact, a business object business artifact and a data business artifact.

20. The system of claim 16, wherein said plurality of patterns include a service request application pattern and said at least one of said plurality of business artifacts associated with said service request application pattern includes an activity business artifact, a business object business artifact and a data business artifact.

21. The system of claim 16, wherein said plurality of patterns include a web-based application pattern and said at least one of said plurality of business artifacts associated with said web-based application pattern includes a user-interface business artifact, a business object business artifact and data business artifact.

22. The system of claim 16, wherein said plurality of patterns include a reporting pattern and said at least one of said plurality of business artifacts associated with said reporting pattern includes a user interface business artifact and a data business artifact.

23. The system of claim 16, further comprising a plurality of business artifact services and wherein said code interfaces with said at least one platform independent service via said business artifact services.

24. The system of claim 23, wherein said business artifact services includes a workflow framework, an activity framework, user interface services, a business object framework and database application.

25. The system of claim 16, wherein said platform independent services include logging services, security services, messaging services and transaction services.

26. The system of claim 16, wherein said at least one platform independent service interfaces with a platform specific adapter.

27. The system of claim 26, wherein said platform specific adapter is selected from a group including an NT adapter, a Solaris adapter and a S390 adapter.

28. The system of claim 16, wherein a workflow is formed using said at least one of said plurality of business artifacts.

29. The system of claim 16, wherein said application is modified by changing at least one of said plurality of business artifacts associated with said selected one of said plurality of patterns and regenerating said code based on said at least one of said plurality of business artifacts.

30. The system of claim 16, wherein said code into converted by said forward engineering module into an executable format.

31. A method for developing an application, comprising:
a means for selecting one of a plurality of patterns, each of said plurality of patterns having at least one of a plurality of business artifacts;
a means for designing said application using said at least one of said plurality of business artifacts associated with said selected one of said plurality of patterns;
a means for generating code based on said at least one of said plurality of business artifacts; and
a means interfacing said code with at least one platform independent service.
